(19) United States
(12) Patent Application Publication
(10) Pub. No.: US 2008/0023158 A1
(43) Pub. Date: Jan. 31, 2008

(54) FIXED STRUCTURE OF ATTACHING BLACKOUT FABRIC AND CURTAIN

(76) Inventor: Ju-Chang Chen, Taipei City (TW)

Correspondence Address: SCHMEISER, OLSEN & WATTS, 22 CENTURY HILL DRIVE, SUITE 302, LATHAM, NY, 12110, US

(21) Appl. No.: 11/461,013

(22) Filed: Jul. 31, 2006

(51) Int. Cl. E06B 3/80

(52) U.S. Cl. 160/179; 160/330

(57) ABSTRACT

The present invention provides a fixed structure of attaching curtain and blackout fabric, comprising: a blackout fabric, a plurality of straps and a plurality of fixed objects. A plurality of holes are provided on a surface area of the blackout fabric, and the holes of the blackout fabric are corresponding to gaps of a curtain. Head portions are formed at the straps for locking in between the gaps of the curtain, and locking units also are provided within the straps for passing through the holes of the blackout fabric. A plurality of fixed openings are formed in the fixed objects for the straps to penetrate through. The blackout fabric is attached onto the black side of the curtain, thus the fixed structure of the present invention can block the sunlight off without affecting or changing the appearance of the curtain.

### BACKGROUND OF THE INVENTION

1. Field of Invention

The present invention relates a fixed structure of attaching a blackout fabric and a curtain, particularly, the present invention relates an improved fixed structure that can block off the sunlight without affecting or altering the appearance of the curtain.

2. Description of the Related Art

The natural habitat of our planet is increasingly polluted and damaged every day, the severe pollution and damage that we induced resulting the ozonosphere of the earth that is there to protect all living things from the sun becomes thinner every year. The ultraviolet (UV) light from the sun becomes increasingly dangerous and harmful to our skin. When we expose a certain amount of time outdoor under the sunlight, some sun block cream or oil, or other sun block accessories are required to be applied or worn in order to reduce the harm caused by the UV rays to our skin. However, indoor activities do not guarantee the prevention of harm from the UV light, particularly, most of people are not use to apply sun block inside the houses. Thus, the most effective way of protecting the harm from the UV light is to add some specific curtain to block off the sunlight directly entering the houses.

Varieties of curtains are available on the market for different purposes, such as the Venetian shades can be used for reducing the sun's rays, when the sunlight is less powerful, the Venetian shades can be rolled up or adjusted in a certain angle to expose the landscape. The Venetian shades utilizes a plurality of shades to block off or seal off the sun rays in a powerful sunny day. In order to effectively reduce the damage of the UV rays from the sun, a blackout fabric is used by directly adhering onto the window to block off the sun rays. Although the blackout fabric adhered onto the window can reduce the sun rays entering the house drastically, but view of the outdoor landscape would be block off from the user. Further, the cleaning process of the curtain and the window would be difficult.

### SUMMARY OF THE INVENTION

It is an object of the present invention to provide an improved fixed structure that can block off the sunlight without affecting or altering the appearance of the curtain.

If is another object of the present invention to provide a fixed structure of attaching blackout fabric and curtain that can be washed and cleaned easily without affecting the appearance of the curtain.

The fixed structure of attaching curtain and blackout fabric of the present invention comprises a blackout fabric, a plurality of straps and a plurality of fixed objects. A plurality of holes are provided on a surface area of the blackout fabric, and the holes of the blackout fabric are corresponding to gaps of a curtain. Head portions are formed at the straps for locking in between the gaps of the curtain, and locking units also are provided within the straps for passing through the holes of the blackout fabric. A plurality of fixed openings are formed in the fixed objects for the straps to penetrate through. The blackout fabric is attached onto the black side of the curtain, thus the fixed structure of the present invention can block the sunlight off without affecting or changing the appearance of the curtain.

Both the forgoing general description and the following detailed description are exemplary and explanatory only and are not restrictive of the invention, as claimed.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the invention. In the drawings,

FIG. 1 is a 3-D assembly view of a fixed structure of attaching curtain and blackout fabric in accordance with a preferred example of the present invention;

FIG. 2 a 3-D view of an integrated fixed structure of attaching curtain and blackout fabric in accordance with the preferred example of the present invention;

FIG. 3 is a schematic view of the integrated fixed structure of attaching curtain and black fabric in accordance with the preferred example of the present invention.

### DESCRIPTION OF THE PREFERRED EMBODIMENTS

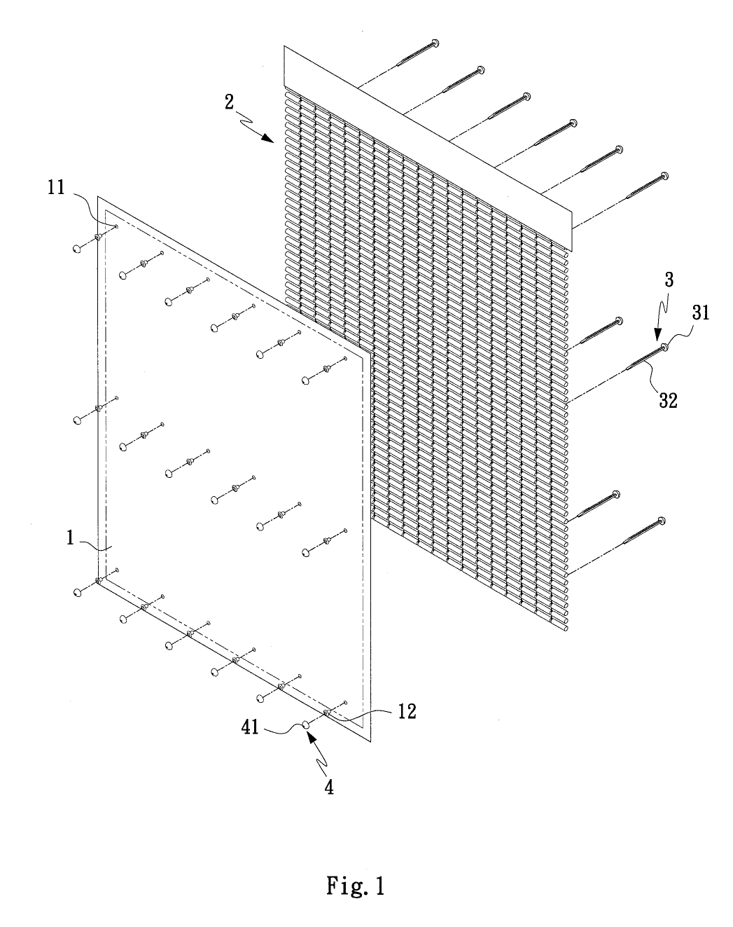

Refer to FIG. 1, a 3-D assembly view of a fixed structure of attaching curtain and blackout fabric in accordance with a preferred example of the present invention. The fixed structure of attaching the curtain and the blackout fabric comprises a blackout fabric 1 having a plurality of the holes 11 on its surface, wherein the holes 11 of the blackout fabric 1 are corresponding to a plurality of gaps of a curtain 2, and sleeve(s) 12 is installed inside the holes 11 of the blackout fabric 1.

A plurality of straps 3 which are integrated within head portions 31 of the gaps located in between the curtain 2 can access through the holes 11 of the blackout fabric 1 and locking units 32 of the sleeves 12. The locking units 32 are configured into teeth strip shaped structures. A plurality of fixed objects 4 have a plurality of fixed openings 41 for positioning the straps 3 by penetrating the straps 3 through the fixed openings 41, and the inner portions of the fixed openings 41 are formed with teeth shaped structures.

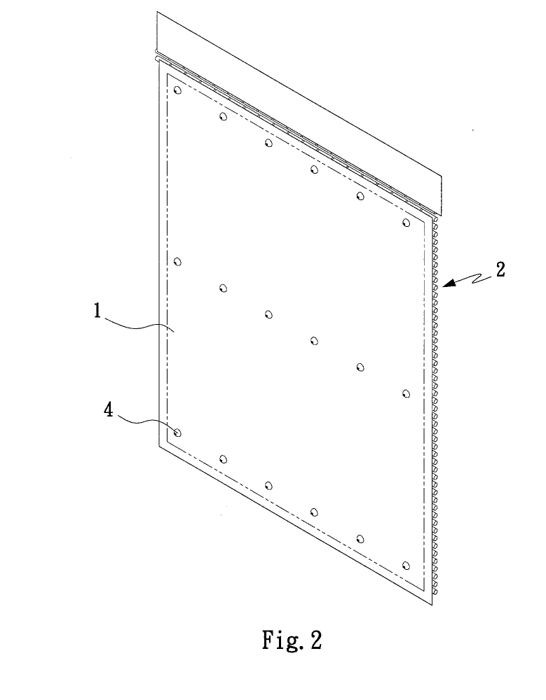

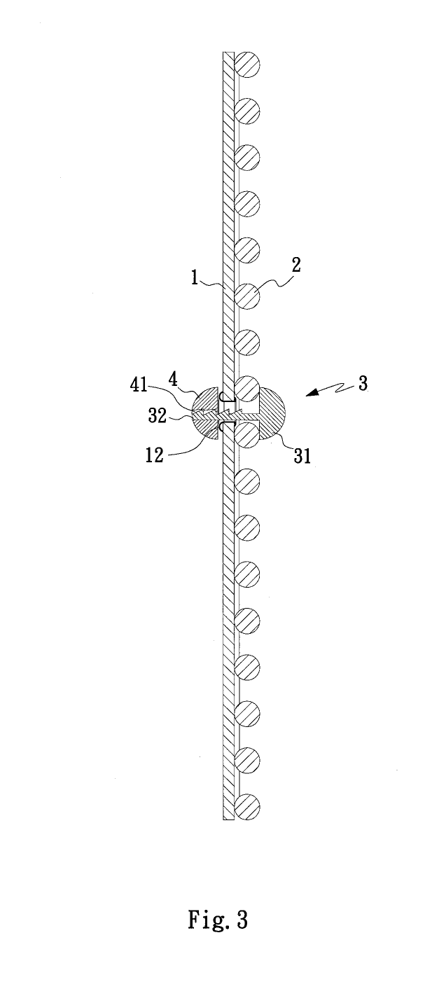

FIGS. 2 and 3 show a 3-D view of an integrated fixed structure of attaching curtain and blackout fabric in accordance with the preferred example of the present invention, and a schematic view of the integrated fixed structure of attaching curtain and black fabric. The blackout fabric 1 is placed to the back side of the curtain 2, and the locking units 32 of the straps 3 are penetrated respectively and sequentially through the gaps of the curtain 2, the sleeves 12 of the blackout fabric 1 and the fixed openings 41 of the fixed objects 4, wherein the free ends of the locking units 32 are being pull in such that the fixed objects 4 can be slid to the surface area of the blackout fabric 1. Simultaneously, the fixed objects 4 are hooked onto the locking units 32, and the head portions 31 of the straps 3 are locked within the gaps of the curtain 2. The protruding portions of the locking units 32 that are located outside the fixed openings 41 of the fixed objects 4 are then removed away, the blackout fabric 1 is therefore attached firmly onto the curtain 2.

The present invention provides an improved design of fixed structure of attaching the blackout fabric and the curtain that can block off the sunlight without affecting the original appearance of the curtain 2. Since the blackout fabric is attached onto the black side of the curtain 2, thus the appearance of curtain would not be altered or affected. The fixed structure of the present invention can also be washed and cleaned easily.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A fixed structure of attaching curtain and blackout fabric, comprising:
a blackout fabric, having a plurality of holes provided on a surface area thereof, and the holes of the blackout fabric are corresponding to gaps of a curtain;
a plurality of straps, having head portions that are locked firmly in the gaps of the curtain, and locking units are provided within the straps for passing through the holes of the blackout fabric; and
a plurality of fixed objects, further comprising fixed openings for the straps to access through.

2. The fixed structure of claim 1, wherein the locking units are configured into teeth strip shaped structures, and inner portions of the fixed openings of the fixed objects are formed with teeth shaped structures.

3. The fixed structure of claim 1, wherein the holes of the blackout fabric further comprise a sleeve.
